(19) United States
(12) Patent Application Publication
(10) Pub. No.: US 2018/0015697 A1
(43) Pub. Date: Jan. 18, 2018

(54) COMPOSITION FOR FORMING PLATING LAYER, FILM HAVING PLATING LAYER PRECURSOR LAYER, FILM HAVING PATTERNED PLATING LAYER, CONDUCTIVE FILM, AND TOUCH PANEL

(71) Applicant: FUJIFILM CORPORATION, Tokyo (JP)

(72) Inventor: Takahiko ICHIKI, Kanagawa (JP)

(73) Assignee: FUJIFILM CORPORATION, Tokyo (JP)

(21) Appl. No.: 15/716,653

(22) Filed: Sep. 27, 2017

Related U.S. Application Data
(63) Continuation of application No. PCT/JP2016/060486, filed on Mar. 30, 2016.

(30) Foreign Application Priority Data
Mar. 31, 2015 (JP) 2015-071176

(51) Int. Cl. B32B 15/08; C23C 18/18; C08F 220/56; C25D 5/56; C08F 2/44

(52) U.S. Cl. CPC B32B 15/08; C25D 5/56; C08F 2/44; C08F 220/56; C23C 18/18

(57) ABSTRACT

Provided are a composition for forming a plating layer, which is capable of forming a metal layer having excellent conductivity by means of a plating treatment and is capable of forming a plating layer having excellent adhesiveness to the metal layer, as well as a film having a plating layer precursor layer, a film having a plating layer, a conductive film, and a touch panel, each of which uses the composition for forming a plating layer.

The composition for forming a plating layer according to the present invention includes a non-polymerizable polymer having a group capable of interacting with a metal ion, a polyfunctional monomer having two or more polymerizable functional groups, a monofunctional monomer, and a polymerization initiator.

### CROSS-REFERENCE TO RELATED APPLICATIONS

This application is a Continuation of PCT International application Ser. No. PCT/JP2016/060486 filed on Mar. 30, 2016, which claims priority under 35 U.S.C. § 119(a) to Japanese Patent Application No. 2015-071176 filed on Mar. 31, 2015. The above application is hereby expressly incorporated by reference, in its entirety, into the present application.

### BACKGROUND OF THE INVENTION

### 1. Field of the Invention

The present invention relates to a composition for forming a plating layer, a film having a plating layer precursor layer, a film having a patterned plating layer, a conductive film, and a touch panel.

### 2. Description of the Related Art

A conductive film having a conductive layer (conductive thin wire) formed on a substrate has been used for various purposes. Particularly, in recent years, along with an increase in the rate at which a touch panel has been mounted on mobile phones or portable game devices, a demand for a conductive film for an electrostatic capacitance touch panel sensor capable of carrying out multi-point detection has been rapidly increasing.

For the formation of such a conductive layer, for example, a method using a patterned plating layer has been proposed.

For example, JP2009-218509A discloses “a method for forming a conductive layer including (a) a step of forming a resin layer made of a thermosetting resin composition containing a radical polymerizable compound and a thermosetting resin and having a gelling time at 70° C. of 60 minutes or shorter (resin layer A), on an organic resin substrate, (b) a step of forming a resin layer containing a resin having a functional group capable of interacting with an electroless plating catalyst or a precursor thereof, a radical generator, and a radical polymerizable compound and capable of adsorbing an electroless plating catalyst or a precursor thereof (resin layer B), (c) a step of applying an electroless plating catalyst or a precursor thereof to the layer capable of adsorbing an electroless plating catalyst or a precursor thereof (resin layer B), and (d) a step of carrying out electroless plating to form an electroless plating film” as a method for forming a conductive layer which has excellent adhesiveness to a substrate, and exhibits excellent suitability for a low temperature process capable of achieving improvement of adhesiveness with favorable sensitivity in the case of using light for energy.

### SUMMARY OF THE INVENTION

Meanwhile, in order to cope with recent demands for miniaturization and high performance of electronic equipment and electronic devices, thinning of wirings and narrowing of pitches in conductor circuits are progressing. Therefore, further improvements in adhesiveness of the wiring to the substrate and conductivity of the wiring have been required.

The present inventors have prepared a conductive layer having a patterned plating layer (that is, a film having a metal layer formed through deposition of metal plating on the surface of the patterned plating layer) with reference to the resin layer B of JP2009-218509A and then have found that the adhesiveness between the patterned plating layer and the metal layer may be insufficient in some cases with respect to the level recently required. Further, it has been found that the metal layer formed on the patterned plating layer exhibits a high resistance value due to a thin film thickness, and a further improvement is also necessary in terms of conductivity of the metal layer.

The present invention has been made in consideration of the above-described circumstances, and an object of the present invention is to provide a composition for forming a plating layer, which is capable of forming a metal layer having excellent conductivity by means of a plating treatment and is capable of forming a patterned plating layer having excellent adhesiveness to the metal layer.

Another object of the present invention is to provide a film having a plating layer precursor layer, a film having a patterned plating layer, a conductive film, and a touch panel, each of which uses the composition for forming a plating layer.

As a result of extensive studies on the foregoing problems, the present inventors have found that the foregoing problems can be solved according to a composition for forming a plating layer which uses a combination of a non-polymerizable polymer having a group capable of interacting with a metal ion, a polyfunctional monomer having two or more polymerizable functional groups, and a monofunctional monomer.

That is, the present inventors have found that the foregoing problems can be solved by the following configurations.

(1) A composition for forming a plating layer, comprising a non-polymerizable polymer having a group capable of interacting with a metal ion,
a polyfunctional monomer having two or more polymerizable functional groups,
a monofunctional monomer, and
a polymerization initiator.
(2) The composition for forming a plating layer according to (1), in which the polymer has a repeating unit containing a carboxylic acid group or a sulfonic acid group.
(3) The composition for forming a plating layer according to (1) or (2), in which the polymer is poly(meth)acrylic acid.
(4) The composition for forming a plating layer according to any one of (1) to (3), in which at least one of the polyfunctional monomer or the monofunctional monomer has a (meth)acrylamide group.
(5) The composition for forming a plating layer according to any one of (1) to (4), in which the monofunctional monomer contains at least a compound represented by General Formula (1),

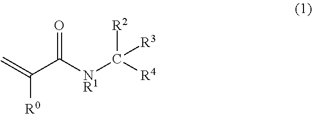

where R⁰ represents a hydrogen atom or an alkyl group having 1 to 4 carbon atoms, R¹ represents a hydrogen atom or an alkyl group having 1 to 4 carbon atoms, R², R³, and R⁴ each independently represent a hydrogen atom, a hydroxy group, an alkyl group having 1 to 10 carbon atoms, or a hydrocarbon chain partially having a substituent selected from an ether group, a carbonyl group, a carboxyl group, and a hydroxy group.
(6) The composition for forming a plating layer according to any one of (1) to (5), in which the polyfunctional monomer contains at least a tetrafunctional (meth)acrylamide.
(7) The composition for forming a plating layer according to any one of (1) to (6), in which the content of the monofunctional monomer is 10 to 100,000 parts by mass with respect to 100 parts by mass of the polyfunctional monomer.
(8) The composition for forming a plating layer according to any one of (1) to (7), in which the total content of the polyfunctional monomer and the monofunctional monomer is 10 to 1,000 parts by mass with respect to 100 parts by mass of the polymer.
(9) A film having a plating layer precursor layer, comprising a substrate and a plating layer precursor layer formed of the composition for forming a plating layer according to any one of (1) to (8) on the substrate.
(10) The film having a plating layer precursor layer according to (9), further comprising a primer layer between the substrate and the plating layer precursor layer.
(11) A film having a patterned plating layer, in which the plating layer precursor layer in the film having a plating layer precursor layer according to (9) or (10) is cured in a patternwise manner by energy application to form a patterned plating layer.
(12) A conductive film obtained by laminating a metal layer on the patterned plating layer of the film having a patterned plating layer according to (11).
(13) A touch panel comprising the conductive film according to (12).

According to the present invention, it is possible to provide a composition for forming a plating layer, which is capable of forming a metal layer having excellent conductivity by means of a plating treatment and is capable of forming a patterned plating layer having excellent adhesiveness to the metal layer.

Further, according to the present invention, it is possible to provide a film having a plating layer precursor layer, a film having a patterned plating layer, a conductive film, and a touch panel, each of which uses the composition for forming a plating layer.

### BRIEF DESCRIPTION OF THE DRAWINGS

FIG. 1 is a cross-sectional view schematically showing an example of an embodiment of a conductive film of the present invention.

FIG. 2A is a cross-sectional view schematically showing an example of a step of obtaining a film having a plating layer precursor layer 10.

FIG. 2B is a cross-sectional view schematically showing an example of a step of curing a coating film 30 of the film having a plating layer precursor layer 10 by energy application.

FIG. 2C is a cross-sectional view schematically showing an example of a step of obtaining a film having a patterned plating layer 50.

FIG. 2D is a cross-sectional view schematically showing an example of a step of forming a metal layer 22 on a patterned plating layer 20 to obtain a conductive film 100.

FIG. 3 is a cross-sectional view schematically showing another example of the embodiment of the conductive film of the present invention.

### DESCRIPTION OF THE PREFERRED EMBODIMENTS

Hereinafter, the composition for forming a plating layer according to the present invention will be described in detail. In the present specification, the numerical range expressed using “to” means a range including numerical values described before and after “to” as a lower limit value and an upper limit value, respectively.

[Composition for Forming Plating Layer]

The composition for forming a plating layer according to the present invention is characterized by combined use of a non-polymerizable polymer having a group capable of interacting with a metal ion, a polyfunctional monomer having two or more polymerizable functional groups, and a monofunctional monomer as components of a patterned plating layer.

More specifically, by mixing the monofunctional monomer in the film-forming components, the distance between the crosslinking points formed by the polyfunctional monomer having two or more polymerizable functional groups is widened, whereby a coarse film having many voids can be formed. In the plating treatment, a plating liquid or a catalyst liquid penetrates into the voids, whereby metal plating is deposited from the deep portion of the patterned plating layer, so that the thickness of the metal layer film can be increased. That is, the resistance of the metal layer can be made small. On the other hand, adhesiveness between the patterned plating layer and the metal layer can also be improved by the anchor effect due to the voids.

In addition, as described above, since the distance between the crosslinking points formed by the polyfunctional monomer having two or more polymerizable functional groups is increased by the monofunctional monomer, the composition for forming a plating layer also has an advantage that curing shrinkage in the case of curing hardly occurs. In the case where a patterned plating layer is formed with the composition for forming a plating layer which does not contain a monofunctional monomer as described in JP2009-218509A, the shear strain becomes higher due to curing shrinkage. In the case where a metal layer is formed on such a patterned plating layer by means of a plating treatment, peeling at the substrate interface and cohesive failure of the patterned plating layer tend to occur. On the other hand, the composition for forming a plating layer according to the present invention is hardly susceptible to curing shrinkage, so that peeling at the substrate interface and cohesive failure of the patterned plating layer are suppressed.

In addition, in the case where the composition for forming a plating layer according to the present invention is used, the difference (development discrimination) between the resistance to dissolution of the non-exposed part (image part) and the solubility of the exposed part (non-image part) in a developer is satisfactory in the case of forming a patterned plating layer, and it is possible to draw a fine line with higher quality.

Hereinafter, first, the components that can be contained in the composition for forming a plating layer according to the present invention will be described in detail.

<Non-Polymerizable Polymer Having Group Capable of Interacting With Metal Ion>

The composition for forming a plating layer includes a non-polymerizable polymer having a group capable of interacting with a metal ion.

The term “non-polymerizable polymer” is intended to have substantially no polymerizable functional group in the polymer, and the content of the polymerizable functional group is preferably 0.1 mass % or less and more preferably 0.01 mass % or less, based on the total mass of the polymer. The lower limit of the content of the polymerizable functional group is not particularly limited, but it may be 0 mass %. The polymerizable functional group has the same definition as the polymerizable functional group of a polyfunctional monomer having two or more polymerizable functional groups which will be described later.

The group capable of interacting with a metal ion (hereinafter, also referred to as an “interacting group”) is intended to mean a functional group capable of interacting with a plating catalyst or a precursor thereof to be applied to the patterned plating layer. A usable interacting group is, for example, a functional group capable of forming an electrostatic interaction with a plating catalyst or a precursor thereof, or a nitrogen-containing functional group, a sulfur-containing functional group, an oxygen-containing functional group, or the like capable of forming a coordination with a plating catalyst or a precursor thereof.

More specific examples of the interacting group include nitrogen-containing functional groups such as an amino group, an amide group, an imide group, a urea group, a tertiary amino group, an ammonium group, an amidino group, a triazine ring, a triazole ring, a benzotriazole group, an imidazole group, a benzimidazole group, a quinoline group, a pyridine group, a pyrimidine group, a pyrazine group, a nazoline group, a quinoxaline group, a purine group, a triazine group, a piperidine group, a piperazine group, a pyrrolidine group, a pyrazole group, an aniline group, a group containing an alkylamine structure, a group containing an isocyanuric structure, a nitro group, a nitroso group, an azo group, a diazo group, an azido group, a cyano group, and a cyanate group; oxygen-containing functional groups such as an ether group, a hydroxy group, a phenolic hydroxy group, a carboxylic acid group, a carbonate group, a carbonyl group, an ester group, a group containing an N-oxide structure, a group containing an S-oxide structure, and a group containing an N-hydroxy structure; sulfur-containing functional groups such as a thiophene group, a thiol group, a thiourea group, a thiocyanuric acid group, a benzthiazole group, a mercaptotriazine group, a thioether group, a thioxy group, a sulfoxide group, a sulfone group, a sulfite group, a group containing a sulfoximine structure, a group containing a sulfoxonium salt structure, a sulfonic acid group, and a group containing a sulfonic acid ester structure; phosphorus-containing functional groups such as a phosphate group, a phosphoramide group, a phosphine group, and a group containing a phosphoric acid ester structure; and groups containing halogen atoms such as chlorine and bromine. In the case of a functional group having a salt structure, a salt thereof can also be used.

Among these, an ionic polar group such as a carboxylic acid group, a sulfonic acid group, a phosphoric acid group, or a boronic acid group, an ether group, or a cyano group is particularly preferable from the viewpoint of high polarity and high adsorption ability to a plating catalyst or a precursor thereof. Further, a carboxylic acid group (carboxyl group) or a sulfonic acid group is more preferable from the viewpoint that developability can be imparted simultaneously with an adsorption ability to a plating catalyst or a precursor thereof or the like, and a carboxylic acid group is preferable from the viewpoint of moderate acidity (not decomposing other functional groups).

Two or more interacting groups may be contained in the polymer.

The non-polymerizable polymer having a group capable of interacting with a metal ion is not particularly limited, but it may be, for example, a polymer having a repeating unit (A) represented by General Formula (2).

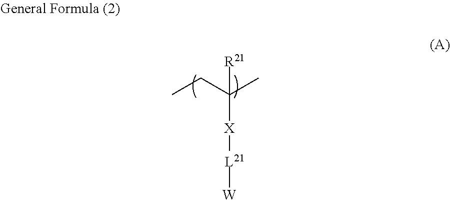

In General Formula (2), R²¹ represents a hydrogen atom or a substituted or unsubstituted alkyl group (for example, a methyl group, an ethyl group, a propyl group, or a butyl group). The type of the substituent is not particularly limited, and examples thereof include a methoxy group, a chlorine atom, a bromine atom, and a fluorine atom.

R²¹ is preferably a hydrogen atom, a methyl group, or a methyl group substituted with a bromine atom.

In General Formula (2), X represents a single bond or a substituted or unsubstituted divalent organic group. The type of the substituent is not particularly limited, and examples thereof include a methoxy group, a chlorine atom, a bromine atom, and a fluorine atom.

Examples of the divalent organic group include a substituted or unsubstituted divalent aliphatic hydrocarbon group (preferably an alkylene group having 1 to 8 carbon atoms, such as a methylene group, an ethylene group, or a propylene group), a substituted or unsubstituted divalent aromatic hydrocarbon group (preferably having 6 to 12 carbon atoms, such as a phenylene group), —O—, —S—, —SO₂—, —N(R)— (R: an alkyl group (preferably having 1 to 8 carbon atoms)), —CO—, —NH—, —COO—, —CONH—, and a group formed by combining these groups (for example, an alkyleneoxy group, an alkyleneoxycarbonyl group, or an alkylenecarbonyloxy group).

X is preferably a single bond, an ester group (—COO—), an amide group (—CONH—), an ether group (—O—), or a substituted or unsubstituted divalent aromatic hydrocarbon group and more preferably a single bond, an ester group (—COO—), or an amide group (—CONH—), from the viewpoint of easy synthesis of a polymer and more excellent adhesiveness of a metal layer.

In General Formula (2), L²¹ represents a single bond or a substituted or unsubstituted divalent organic group. The substituted or unsubstituted divalent organic group has the same definition as the substituted or unsubstituted divalent organic group represented by X.

L²¹ is preferably a single bond, a substituted or unsubstituted divalent aliphatic hydrocarbon group, a substituted or unsubstituted divalent aromatic hydrocarbon group, or a group formed by combining these groups, from the viewpoint of more excellent adhesiveness of a metal layer. Among these, L²¹ is preferably a single bond or a substituted or unsubstituted divalent organic group having a total of 1 to 15 carbon atoms, and is particularly preferably an unsubstituted divalent organic group having a total of 1 to 15 carbon atoms. Here, the total number of carbon atoms refers to a total number of carbon atoms contained in the substituted or unsubstituted divalent organic group represented by L²¹.

In General Formula (2), W represents an interacting group. The interacting group is as defined above.

Among the above, poly(meth)acrylic acid is particularly preferable because it is easy to synthesize. In the present invention, the term (meth)acrylic acid is a concept including both acrylic acid and methacrylic acid.

From the viewpoint of adsorptivity to a plating catalyst or a precursor thereof, the content of the interacting group unit (repeating unit (A)) is preferably 5 to 100 mol % and more preferably 10 to 100 mol %, with respect to the total repeating units in the polymer.

Incidentally, the polymer may contain a repeating unit other than the above-mentioned repeating unit (A), and examples thereof include repeating units derived from known monomers (for example, a styrene monomer, an olefin monomer, and an acrylic monomer) not containing an interacting group.

The weight-average molecular weight of the non-polymerizable polymer having a group capable of interacting with a metal ion is not particularly limited, but it is preferably 1,000 or more and 700,000 or less and more preferably 2,000 or more and 200,000 or less from the viewpoint that handleability such as solubility is superior. In particular, it is preferably 20,000 or more from the viewpoint of polymerization sensitivity.

These polymers can be produced by known methods.

The weight-average molecular weight of the non-polymerizable polymer having a group capable of interacting with a metal ion can be confirmed using gel permeation chromatography (GPC). That is, in order to determine the weight-average molecular weight of the non-polymerizable polymer having a group capable of interacting with a metal ion by GPC, calculation may be made based on the calibration curve of the relationship between retention time and molecular weight, which is obtained by measuring several types of polymers (for example, polystyrenes) having known molecular weights different from each other under the same conditions.

More specifically, as a GPC measurement method, the object is dissolved in tetrahydrofuran (THF) and then the weight-average molecular weight can be calculated in terms of polystyrene using a high-speed GPC apparatus (for example, HLC-8220 GPC (manufactured by Tosoh Corporation)). The conditions for GPC measurement are as follows.

Column: TSK-GEL SuperH manufactured by Tosoh Corporation

Column temperature: 40° C.

Flow rate: 1 mL/min

Eluent: THF

<Polyfunctional Monomer Having Two or More Polymerizable Functional Groups>

The polyfunctional monomer having two or more polymerizable functional groups (hereinafter, also referred to as a “polyfunctional monomer”) may have two or more polymerizable functional groups, but the number of the polymerizable functional groups is preferably 2 to 10 and more preferably 2 to 6 from the viewpoint that the conductive properties of a metal layer and/or adhesiveness of a metal layer are more excellent (hereinafter, simply referred to as “the effects of the present invention are more excellent”).

The molecular weight of the polyfunctional monomer is not particularly limited, but it is preferably 150 to 1,000 and more preferably 200 to 800, from the viewpoint that the effects of the present invention are more excellent.

The polyfunctional monomer may contain the above-mentioned interacting group.

The polymerizable functional group is a functional group capable of forming a chemical bond by energy application, and examples thereof include a radically polymerizable functional group and a cationically polymerizable functional group. Among them, a radically polymerizable functional group is preferable from the viewpoint of more excellent reactivity. Examples of the radically polymerizable functional group include an unsaturated carboxylic acid ester group such as an acrylic acid ester group (acryloyloxy group), a methacrylic acid ester group (methacryloyloxy group), an itaconic acid ester group, a crotonic acid ester group, an isocrotonic acid ester group, or a maleic acid ester group, a styryl group, a vinyl group, an acrylamide group, and a methacrylamide group. Among them, a methacryloyloxy group, an acryloyloxy group, a vinyl group, a styryl group, an acrylamide group, or a methacrylamide group is preferable, and an acrylamide group, a methacrylamide group, a methacryloyloxy group, an acryloyloxy group, or a styryl group is more preferable.

Among the above-mentioned polyfunctional monomers, a polyfunctional (meth)acrylamide is preferably used from the viewpoint that hardness of a patterned plating layer to be formed is more excellent.

The polyfunctional (meth)acrylamide is not particularly limited as long as it has two or more (preferably two or more and six or less) (meth)acrylamide groups. Among them, a tetrafunctional (meth)acrylamide having four (meth)acrylamide groups is preferable.

From the viewpoint that the effects of the present invention are more excellent, one preferred embodiment of the polyfunctional monomer may be, for example, a compound represented by General Formula (X).

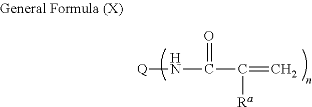

In General Formula (X), Q represents an n-valent linking group, and R^{a} represents a hydrogen atom or a methyl group. n represents an integer of 2 or more.

R^{a} represents a hydrogen atom or a methyl group and preferably a hydrogen atom.

The valence n of Q is 2 or more, preferably 2 or more and 6 or less, more preferably 2 or more and 5 or less, and still more preferably 2 or more and 4 or less, from the viewpoint that the effects of the present invention are more excellent.

Examples of the n-valent linking group represented by Q include a group represented by General Formula (1A), a group represented by General Formula (1B),

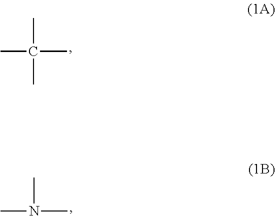

—NH—, —NR— (R represents an alkyl group), —O—, —S—, a carbonyl group, an alkylene group, an alkenylene group, an alkynylene group, a cycloalkylene group, an aromatic group, a heterocyclic group, and a group formed by combining two or more of these groups.

With respect to the compound represented by General Formula (X), reference may be appropriately made to the description of paragraphs [0019] to [0034] of JP2013-43946A and paragraphs [0070] to [0080] of JP2013-43945A.

From the viewpoint that the effects of the present invention are more excellent, a suitable embodiment of the compound represented by General Formula (X) may be, for example, a compound represented by General Formula (Y).

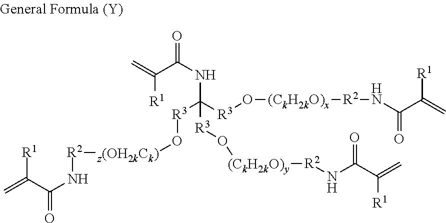

In General Formula (Y), R¹ represents a hydrogen atom or a methyl group. R² represents a linear or branched alkylene group having 2 to 4 carbon atoms, provided that R² does not have a structure in which oxygen atoms and nitrogen atoms bonded to both ends of R² are bonded to the same carbon atom of R². R³ represents a divalent linking group. k represents 2 or 3. x, y, and z each independently represent an integer of 0 to 6, and x+y+z satisfies 0 to 18.

R² represents a linear or branched alkylene group having 2 to 4 carbon atoms. The plurality of R²⁻'s may be the same as or different from each other. R² is preferably an alkylene group having 3 or 4 carbon atoms, more preferably an alkylene group having 3 carbon atoms, and particularly preferably a linear alkylene group having 3 carbon atoms. The alkylene group of R² may further have a substituent, and examples of the substituent include an aryl group and an alkoxy group.

Meanwhile, R² does not have a structure in which oxygen atoms and nitrogen atoms bonded to both ends of R² are bonded to the same carbon atom of R². R² is a linear or branched alkylene group connecting the oxygen atom to the nitrogen atom of the (meth)acrylamide group, and in the case where the alkylene group has a branched structure, it is also conceivable that R² has a —O—C—N— structure (hemiaminal structure) in which the oxygen atom and the nitrogen atom of the (meth)acrylamide group at both the ends are bonded to the same carbon atom in the alkylene group. However, a compound having such a structure is not encompassed by the compound represented by General Formula (Y).

Examples of the divalent linking group of R³ include an alkylene group, an arylene group, a heterocyclic group, and a group formed by combining these groups, among which an alkylene group is preferable. In the case where the divalent linking group contains an alkylene group, the alkylene group may further contain at least one group selected from —O—, —S—, and —NR^{b}—. R^{b} represents a hydrogen atom or an alkyl group having 1 to 4 carbon atoms.

x, y, and z each independently represent an integer of 0 to 6, preferably an integer of 0 to 5, and more preferably an integer of 0 to 3. x+y+z satisfies 0 to 18, preferably 0 to 15, and more preferably 0 to 9.

Among the polyfunctional (meth)acrylamides, a tetrafunctional (meth)acrylamide represented by General Formula (4) can be more preferably used from the viewpoint of an excellent curing rate of the plating layer precursor layer.

In the present invention, the term (meth)acrylamide is a concept including both acrylamide and methacrylamide.

The tetrafunctional (meth)acrylamide represented by General Formula (4) can be produced, for example, by the production method described in JP5486536B.

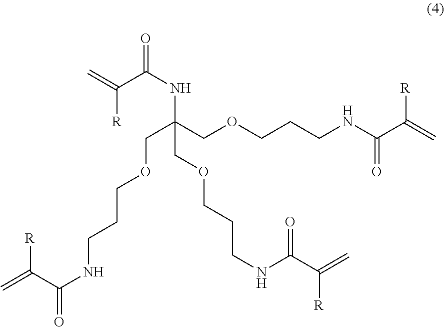

In General Formula (4), R represents a hydrogen atom or a methyl group. In General Formula (4), the plurality of R's may be the same as or different from each other.

<Monofunctional Monomer>

The monofunctional monomer is not particularly limited as long as it is a compound having one polymerizable functional group. Examples of the monofunctional monomer include a compound having an ethylenically unsaturated bond as a compound having addition polymerizability and a compound having an epoxy group as a compound having ring-opening polymerizability. The molecular weight of the monofunctional monomer to be used is preferably 50 to 400 and more preferably 70 to 250.

Specific examples thereof include the compounds having one polymerizable functional group as described above in the description of the polyfunctional monomer. Among them, a compound having an acrylamide group or an α-alkyl substituted acrylamide group (α-alkyl substituted acrylamide group is preferably a methacrylamide group) is preferable, and a compound represented by General Formula (1) is particularly preferable.

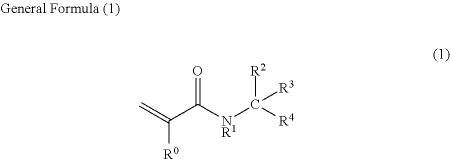

In General Formula (1), R⁰ represents a hydrogen atom or an alkyl group having 1 to 4 carbon atoms, R¹ represents a hydrogen atom or an alkyl group having 1 to 4 carbon atoms, and R², R³, and R⁴ each independently represent a hydrogen atom, a hydroxy group, an alkyl group having 1 to 10 carbon atoms, or a hydrocarbon chain partially having a substituent selected from an ether group, a carbonyl group, a carboxyl group, and a hydroxy group.

In General Formula (1), R⁰ represents a hydrogen atom or an alkyl group having 1 to 4 carbon atoms, and preferably a hydrogen atom or a methyl group.

R¹ represents a hydrogen atom or an alkyl group having 1 to 4 carbon atoms, and preferably a hydrogen atom or a methyl group.

R², R³, and R⁴ each independently represent a hydrogen atom, a hydroxy group, an alkyl group having 1 to 10 carbon atoms, or a hydrocarbon chain partially having a substituent selected from an ether group, a carbonyl group, a carboxyl group, and a hydroxy group.

Examples of the hydrocarbon chain partially having a substituent selected from an ether group, a carbonyl group, a carboxyl group, and a hydroxy group include a hydroxyalkyl group, an alkoxyalkyl group, an acylalkyl group, and a carboxylalkyl group, and the number of carbon atoms in the hydrocarbon chain is preferably 1 to 5 without including the number of carbon atoms in the above substituent.

R², R³, and R⁴ are preferably a hydrogen atom, a hydroxy group, an alkyl group having 1 to 5 carbon atoms, a hydroxyalkyl group, an alkoxymethyl group, or an acylalkyl group, and more preferably a hydrogen atom, a hydroxy group, an alkyl group having 1 to 3 carbon atoms, a hydroxymethyl group, a butoxymethyl group, or an acylmethyl group (preferably an acetylmethyl group).

<Composition of Individual Components>

The content of the non-polymerizable polymer having a group capable of interacting with a metal ion in the composition for forming a plating layer is not particularly limited, but it is preferably 20 mass % or more and more preferably 30 mass % or more, with respect to 100 mass % of the total solid content in the composition for forming a plating layer. The upper limit of the content of the non-polymerizable polymer is not particularly limited, but it is preferably 90 mass % or less.

From the viewpoint of a balance between strength of the patterned plating layer and plating suitability, the content of the monofunctional monomer in the composition for forming a plating layer is preferably 10 to 100,000 parts by mass, more preferably 15 to 50,000 parts by mass, still more preferably 30 to 20,000 parts by mass, and particularly preferably 100 to 15,000 parts by mass, with respect to 100 parts by mass of the polyfunctional monomer.

From the viewpoint of the balance between strength of the patterned plating layer, the deposition rate of the plating, and plating suitability, the total content of the polyfunctional monomer and the monofunctional monomer in the composition for forming a plating layer is preferably 10 to 1,000 parts by mass, more preferably 15 to 1,000 parts by mass, and still more preferably 50 to 500 parts by mass, with respect to 100 parts by mass of the non-polymerizable polymer having a group capable of interacting with a metal ion.

In addition, from the viewpoint of alkali resistance, at least one of the polyfunctional monomer or the monofunctional monomer in the composition for forming a plating layer preferably has a (meth)acrylamide group.

A plurality of types of each of monofunctional monomers and polyfunctional monomers may be contained in the composition for forming a plating layer. In this case, it is preferable to use a combination that has excellent compatibility therebetween.

<Polymerization Initiator>

The composition for forming a plating layer contains a polymerization initiator. By including the polymerization initiator, the reaction between the polymerizable functional groups during the exposure treatment more efficiently proceeds.

The polymerization initiator is not particularly limited, and a known polymerization initiator (so-called photopolymerization initiator) or the like can be used. Examples of the polymerization initiator include benzophenones, acetophenones, α-aminoalkylphenones, benzoins, ketones, thioxanthones, benzyls, benzyl ketals, oxime esters, anthrones, tetramethylthiuram monosulfides, bisacylphosphine oxides, acylphosphine oxides, anthraquinones, azo compounds, and derivatives thereof.

The content of the polymerization initiator in the composition for forming a plating layer is not particularly limited, but from the viewpoint of the curability of the patterned plating layer, the content of the polymerization initiator is preferably 0.1 to 20 mass % and more preferably 1 to 10 mass %, with respect to the total content 100 mass % of the polyfunctional monomer and the monofunctional monomer.

<Solvent>

From the viewpoint of handleability, the composition for forming a plating layer preferably contains a solvent.

Examples of usable solvents include, but are not particularly limited to, water; an alcohol-based solvent such as methanol, ethanol, propanol, ethylene glycol, 1-methoxy-2-propanol, glycerin, or propylene glycol monomethyl ether; an acid such as acetic acid; a ketone-based solvent such as acetone, methyl ethyl ketone, or cyclohexanone; an amide-based solvent such as formamide, dimethylacetamide, or N-methylpyrrolidone; a nitrile-based solvent such as acetonitrile or propionitrile; an ester-based solvent such as methyl acetate or ethyl acetate; a carbonate-based solvent such as dimethyl carbonate or diethyl carbonate; an ether-based solvent, a glycol-based solvent, an amine-based solvent, a thiol-based solvent, and a halogen-based solvent.

Among them, an alcohol-based solvent, an amide-based solvent, a ketone-based solvent, a nitrile-based solvent, or a carbonate-based solvent is preferable.

The content of the solvent in the composition for forming a plating layer is not particularly limited, but it is preferably 50 to 98 mass % and more preferably 70 to 98 mass %, with respect to the total amount of the composition. In the case where the content of the solvent is within the above-specified range, handleability of the composition is excellent and control of the layer thickness of the patterned plating layer, or the like is easy.

<Other Additives>

The composition for forming a plating layer may contain other additives (for example, a sensitizer, a curing agent, a polymerization inhibitor, an antioxidant, an antistatic agent, an ultraviolet absorbing agent, a filler, a particle, a flame retardant, a surfactant, a lubricant, and a plasticizer) as required.

[Film Having Plating Layer Precursor Layer, Film Having Patterned Plating Layer, and Conductive Film]

Hereinafter, the conductive film of the present invention will be described in detail, and the film having a plating layer precursor layer and the film having a patterned plating layer of the present invention will also be described in detail.

The conductive film of the present invention has a substrate, a patterned plating layer formed on the substrate, and a metal layer laminated on the surface of the patterned plating layer by means of a plating treatment.

The conductive film of the present invention can be prepared by a production method having the following Steps 1 and 2.

Step 1: a patterned plating layer forming step of forming a plating layer precursor layer (applied/dried coating film) on a substrate using the composition for forming a plating layer (the film having a substrate and a plating precursor layer formed on the substrate is referred to as a “film having a plating layer precursor layer”), and then curing the plating layer precursor layer in a patternwise manner by energy application to form the patterned plating layer (the film obtained in Step 1 is referred to as a “film having a patterned plating layer”)

Step 2: a metal layer forming step of forming a metal layer on the patterned plating layer by means of a plating treatment

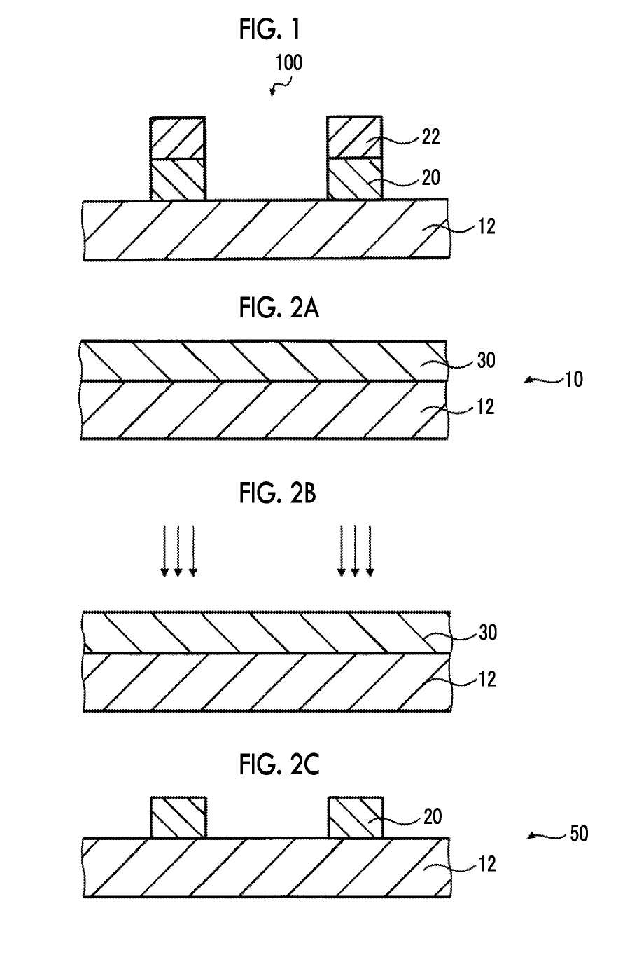

FIG. 1 is a schematic cross-sectional view showing an example of an embodiment of a conductive film of the present invention. A conductive film 100 of FIG. 1 has a substrate 12, a patterned plating layer 20 on the substrate 12, and a metal layer 22 formed on the patterned plating layer 20.

Hereinafter, with reference to the accompanying drawings, a film having a plating layer precursor layer, a film having a plating layer, a method for producing a conductive film, materials thereof, and the like of the present invention will be described by way of example of a method for producing a conductive film 100. The embodiments of the present invention are not limited to the embodiments described below.

(Substrate)

The type of substrate is not particularly limited as long as it has two main surfaces and supports a patterned plating layer described below. The substrate is preferably an insulating substrate. More specifically, a resin substrate, a ceramic substrate, or a glass substrate can be used.

Examples of the material of the resin substrate include polyethylene terephthalate, polyethylene naphthalate, polyether sulfone, a polyacrylic resin, a polyurethane-based resin, polyester, polycarbonate, polysulfone, polyamide, polyarylate, polyolefin, a cellulose-based resin, polyvinyl chloride, and a cycloolefin-based resin. Among these, polyethylene terephthalate, polyethylene naphthalate, or polyolefin is preferable.

The thickness (mm) of the substrate is not particularly limited, but it is preferably 0.05 to 2 mm and more preferably 0.1 to 1 mm from the viewpoint of balance between handleability and thickness reduction.

Further, it is preferred that the substrate properly transmits light. Specifically, the total light transmittance of the substrate is preferably 85% to 100%.

Moreover, the substrate may have a multilayer structure and one of the layers may be a functional film. Further, the substrate may be formed of a functional film. Examples of the functional film include, but are not particularly limited to, a polarizing plate, a phase difference film, a cover plastic, a hard coat film, a barrier film, a pressure sensitive film, an electromagnetic wave shielding film, a heat-generating film, an antenna film, and a wiring film for a device other than a touch panel.

Specific examples of the functional film used for a liquid crystal cell particularly associated with a touch panel include a polarizing plate such as NPF series (manufactured by Nitto Denko Corporation) or HLC2 series (manufactured by Sanritz Corporation); a phase difference film such as a WV film (manufactured by Fujifilm Corporation); a cover plastic such as FAINDE (manufactured by Dai Nippon Printing Co., Ltd.), TECHNOLLOY (manufactured by Sumitomo Chemical Co., Ltd.), IUPILON (manufactured by Mitsubishi Gas Chemical Company), SILPLUS (manufactured by Nippon Steel & Sumikin Chemical Co., Ltd.), ORGA (manufactured by Nippon Synthetic Chemical Industry Co., Ltd.), or SHORAYAL (manufactured by Showa Denko K. K.); and a hard coat film such as H series (manufactured by Lintec Corporation), FHC series (manufactured by Higashiyama Film Co., Ltd.), or a KB film (manufactured by Kimoto Co., Ltd.). These may form a patterned plating layer on the surface of each functional film.

Further, cellulose triacetate may be occasionally used for a polarizing plate or a phase difference film as described in JP2007-26426A. However, from the viewpoint of resistance to a plating process, a cycloolefin (co)polymer can be used in place of cellulose triacetate. For example, ZEONOR (manufactured by Zeon Corporation) or the like may be exemplified.

[Step 1: Patterned Plating Layer Forming Step]

Step 1 is a step of forming a patterned plating layer on a substrate through patternwise application of energy to a coating film formed by a composition for forming a plating layer containing a non-polymerizable polymer having a group capable of interacting with a metal ion, a polyfunctional monomer having two or more polymerizable functional groups, a monofunctional monomer, and a polymerization initiator.

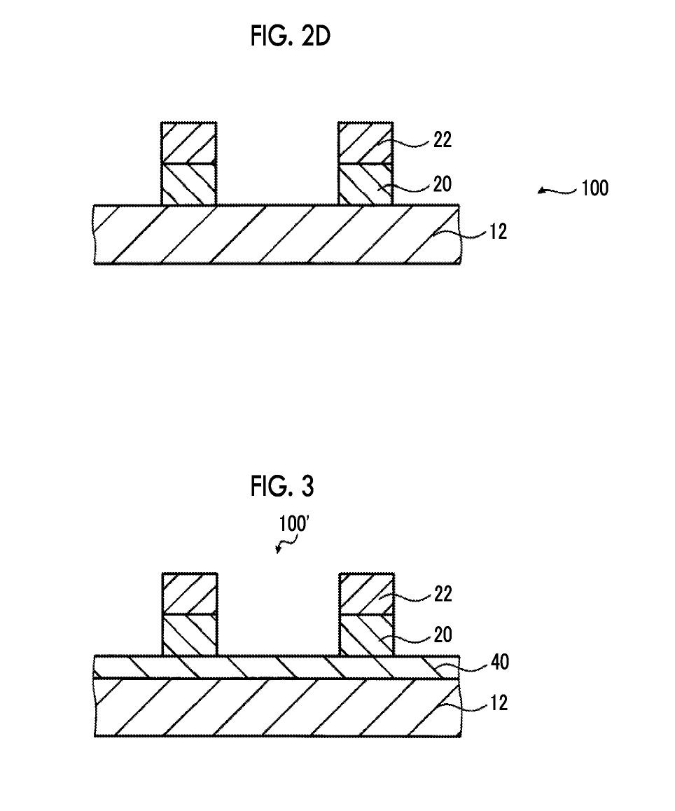

More specifically, Step 1 is a step such that first, as shown in FIG. 2A, a coating film (corresponding to a plating layer precursor layer) 30 of a composition for forming a plating layer is formed on a substrate 12 to prepare a film having a plating layer precursor layer 10, then, as shown in FIG. 2B, energy is applied to the coating film 30 in a patternwise manner as indicated by a black arrow to accelerate the reaction of the polymerizable functional group, so that the coating film 30 is cured, and thereafter the region to which energy was not applied is removed to obtain a patterned plating layer 20 (FIG. 2C).

The patterned plating layer of a film 50 having a patterned plating layer formed by the above step adsorbs (is adhered to) metal ions in Step 2 described later depending on the function of the interacting group. In other words, the patterned plating layer functions as a good metal ion accepting layer. In addition, the polymerizable functional group is utilized for bonding between compounds by means of a curing treatment through energy application, so that a patterned plating layer having excellent firmness and hardness can be obtained.

In Step 1, a composition for forming a plating layer is first placed on a substrate. There is no particular limitation on the method of placing the composition. For example, a method of bringing the composition for forming a plating layer into contact with the substrate to form a coating film of the composition for forming a plating layer may be mentioned. Such a method may be, for example, a method of applying the composition for forming a plating layer onto a substrate (coating method).

In the case of a coating method, the method of applying the composition for forming a plating layer onto the substrate is not particularly limited, and a known method (for example, spin coating, die coating, or dip coating) may be used.

From the viewpoints of handleability and production efficiency, preferred is an embodiment in which a coating film is formed by applying a composition for forming a plating layer onto a substrate and carrying out a drying treatment as necessary to remove the remaining solvent.

Although the conditions of the drying treatment are not particularly limited, it is preferable to carry out the drying treatment at room temperature to 220° C. (preferably 50° C. to 120° C.) for 1 to 30 minutes (preferably 1 to 10 minutes), from the viewpoint of more excellent productivity.

There is no particular limitation on the method of applying energy in a patternwise manner to the coating film on the substrate. For example, a heat treatment or exposure treatment (light irradiation treatment) is preferably used. The exposure treatment is preferable from the viewpoint that the treatment is completed in a short time. By applying energy to the coating film, the polymerizable functional group contained in the compound in the coating film is activated to result in crosslinking between the compounds, and curing of the layer progresses.

For the exposure treatment, ultraviolet (UV) lamp, light irradiation with visible light, or the like is used. Examples of the light source include a mercury lamp, a metal halide lamp, a xenon lamp, a chemical lamp, and a carbon arc lamp. Examples of the radiation include electron beams, X-rays, ion beams, and far infrared rays. Specific embodiments of the exposure treatment suitably include scanning exposure by an infrared laser, high-illumination flash exposure such as a xenon discharge lamp exposure, and infrared lamp exposure.

The exposure time varies depending on the reactivity of the compound and the light source, but it is usually between 10 seconds and 5 hours. The exposure energy may be about 10 to 8,000 mJ and preferably 50 to 3,000 mJ.

The method of carrying out the exposure treatment in a patternwise manner is not particularly limited, and a known method is employed. For example, the coating film may be irradiated with exposure light through a mask.

In addition, in the case where a heat treatment is employed as energy application, an air dryer, an oven, an infrared dryer, a heating drum, or the like may be used.

Next, a portion of the coating film that has not been subjected to energy application is removed to form a patterned plating layer.

The removal method is not particularly limited, and an optimum method is appropriately selected according to the compound to be used. For example, a method in which an alkaline solution (preferably pH: 13.0 to 13.8) is used as a developer can be mentioned. In the case where an alkaline solution is used to remove the portion that has not been subjected to energy application, there are a method of immersing a substrate having an energy-applied coating film in a solution, a method of applying a developer onto the substrate, or the like, among which the immersion method is preferable. In the case of the immersion method, the immersion time is preferably about 1 minute to 30 minutes from the viewpoints of productivity and workability.

Another method may be, for example, a method in which a solvent in which a compound to be used is dissolved is used as a developer and the substrate is immersed in the solvent.

(Pattered Plating Layer)

The thickness of the patterned plating layer formed by the above-mentioned treatment is not particularly limited, but it is preferably 0.01 to 10 μm, more preferably 0.2 to 5 μm, and particularly preferably 0.3 to 1.0 μm, from the viewpoint of productivity.

The pattern shape of the patterned plating layer is not particularly limited, and it is adjusted according to a place where a metal layer described later is desired to be formed. The pattern shape may be, for example, a mesh pattern. In the case of a mesh pattern, a length W of one side of a lattice (opening portion) in the mesh pattern is preferably 800 μm or less and more preferably 600 μm or less and is preferably 50 μm or more and more preferably 400 μm or more. The shape of the lattice is not particularly limited, and it may substantially be a diamond shape or a polygonal shape (for example, a triangular shape, a square shape, or a hexagonal shape). Further, the shape of one side may be a curved shape or an arc shape in addition to a linear shape.

The line width of the patterned plating layer is not particularly limited, but it is preferably 30 μm or less, more preferably 15 μm or less, still more preferably 10 μm or less, particularly preferably 9 μm or less, and most preferably 7 μm or less and is preferably 0.5 μm or more and more preferably 1.0 μm or more, from the viewpoint of low resistance of a metal layer disposed on the patterned plating layer.

[Step 2: Metal Layer Forming Step]

Step 2 is a step in which a metal ion is applied to the patterned plating layer formed in the above-mentioned Step 1, and a plating treatment is carried out on the patterned plating layer to which a metal ion has been applied, so that a metal layer is formed on the patterned plating layer. As shown in FIG. 2D, by carrying out the present step, a metal layer 22 is disposed on a patterned plating layer 20, so a conductive film 100 is obtained.

Hereinafter, the step of applying a metal ion to the patterned plating layer (Step 2-1) and the step of carrying out a plating treatment on the patterned plating layer to which a metal ion has been applied (Step 2-2) will be described separately.

(Step 2-1: Metal Ion Applying Step)

In the present step, a metal ion is first applied to the patterned plating layer. The above-described interacting group derived from a non-polymerizable polymer having a group capable of interacting with a metal ion is adhered (adsorbed) to the applied metal ion depending on the function thereof. More specifically, a metal ion is applied into the patterned plating layer and onto the surface of the patterned plating layer.

The metal ion is one which can become a plating catalyst through a chemical reaction, and more specifically, it becomes a zero-valent metal which is a plating catalyst through a reduction reaction. In the present step, a metal ion may be applied to the patterned plating layer and then converted into a zero-valent metal through a separate reduction reaction before immersion in a plating bath (for example, an electroless plating bath), so that it may be used as a plating catalyst, or the metal ion may be immersed in a plating bath as it is in the form of a metal ion and then converted into a metal (plating catalyst) by means of a reducing agent in the plating bath.

The metal ion is preferably applied to the patterned plating layer using a metal salt. The metal salt to be used is not particularly limited as long as it is dissolved in an appropriate solvent and dissociated into a metal ion and a base (anion), and example thereof include M(NO₃)ₙ, MClₙ, M_{2/n}(SO₄), and M_{3/n}(PO₄) (M represents an n-valent metal atom). As metal ions, those metal ions dissociated from the foregoing metal salts can be suitably used. Specific examples thereof include Ag ions, Cu ions, Al ions, Ni ions, Co ions, Fe ions, and Pd ions, among which those capable of being coordinated at multiple sites are preferable, and Ag ions or Pd ions are particularly preferable from the viewpoints of the number of types of functional groups capable of being coordinated and the catalytic ability.

As a method for applying a metal ion to the patterned plating layer, for example, a solution containing a dissociated metal ion may be prepared by dissolving a metal salt in an appropriate solvent, and then the solution may be applied onto the patterned plating layer, or alternatively, a substrate on which the patterned plating layer is formed may be immersed in the solution.

Water or an organic solvent is appropriately used as the solvent. The organic solvent is preferably a solvent capable of penetrating the patterned plating layer. For example, acetone, methyl acetoacetate, ethyl acetoacetate, ethylene glycol diacetate, cyclohexanone, acetylacetone, acetophenone, 2-(1-cyclohexenyl)cyclohexanone, propylene glycol diacetate, triacetin, diethylene glycol diacetate, dioxane, N-methylpyrrolidone, dimethyl carbonate, or dimethyl cellosolve may be used.

The concentration of the metal ion in the solution is not particularly limited, but it is preferably 0.001 to 50 mass % and more preferably 0.005 to 30 mass %.

The contact time is preferably about 30 seconds to 24 hours and more preferably about 1 minute to 1 hour.

The adsorption amount of metal ions in the patterned plating layer varies depending on the type of plating bath to be used, the type of catalytic metal, the type of interacting group of the patterned plating layer, the method of use, and the like, but it is preferably 5 to 1,000 mg/m², more preferably 10 to 800 mg/m², and particularly preferably 20 to 600 mg/m², from the viewpoint of the deposition of plating.

(Step 2-2: Plating Treatment Step)

Next, a plating treatment is carried out on the patterned plating layer to which a metal ion has been applied.

The method of the plating treatment is not particularly limited, and examples thereof include an electroless plating treatment and an electrolytic plating treatment (electroplating treatment). In the present step, the electroless plating treatment may be carried out alone, or the electrolytic plating treatment may be further carried out after the electroless plating treatment is carried out.

In the present specification, a so-called silver mirror reaction is included as a type of the above-described electroless plating treatment. Accordingly, for example, adhered metal ions are reduced by the silver mirror reaction or the like so that a desired patterned metal layer may be formed and, thereafter, the electrolytic plating treatment may be further carried out.

Hereinafter, the procedures of the electroless plating treatment and the electrolytic plating treatment will be described in detail.

The electroless plating treatment refers to an operation of allowing metals to be deposited through a chemical reaction using a solution in which metal ions expected to be deposited as plating are dissolved.

The electroless plating treatment in the present step is carried out by washing the substrate including the patterned plating layer to which metal ions have been applied with water to remove extra metal ions, and then immersing the substrate in an electroless plating bath. A known electroless plating bath can be used as the electroless plating bath to be used. In addition, metal ions are reduced and then electroless plating is carried out in the electroless plating bath.

Separately from the embodiment of using the above-described electroless plating liquid, the reduction of metal ions in the patterned plating layer can be performed by preparing a catalyst activating liquid (reducing liquid) as a separate step before the electroless plating treatment. The catalyst activating liquid is a liquid in which a reducing agent capable of reducing a metal ion into a zero-valent metal is dissolved, and the concentration of the reducing agent with respect to the entire liquid is preferably 0.1 to 50 mass % and more preferably 1 to 30 mass %. As the reducing agent, a boron-based reducing agent such as sodium borohydride or dimethylamine borane or a reducing agent such as formaldehyde or hypophosphorous acid can be used.

During the immersion, it is preferred that the substrate is immersed by addition of stirring or shaking thereto.

Typically, the composition of the electroless plating bath mainly includes 1. metal ions for plating, 2. a reducing agent, and 3. an additive (stabilizer) that improves the stability of metal ions in addition to a solvent (for example, water). In addition to these, the plating bath may include a known additive such as a stabilizer for a plating bath.

The organic solvent used for the electroless plating bath is required to be a solvent which is soluble in water. From this viewpoint, ketones such as acetone; and alcohols such as methanol, ethanol, and isopropanol are preferably used. As the type of metal used for the electroless plating bath, copper, tin, lead, nickel, gold, silver, palladium, or rhodium is known. Among them, from the viewpoint of conductivity, copper, silver, or gold is preferable and copper is more preferable. Further, an optimal reducing agent and an optimal additive are selected according to the metal.

The time for immersing the substrate in the electroless plating bath is preferably 1 minute to 6 hours and more preferably 1 minute to 3 hours.

The electrolytic plating treatment refers to an operation of allowing metals to be deposited by an electric current using a solution in which metal ions expected to be deposited as plating are dissolved.

Further, in the present step as described above, the electrolytic plating treatment may be carried out as necessary, after the electroless plating treatment. According to such an embodiment, the thickness of the patterned metal layer to be formed can be suitably adjusted.

As the method of electrolytic plating, a conventional known method can be used. Further, examples of metals used for electrolytic plating include copper, chromium, lead, nickel, gold, silver, tin, and zinc. Among them, from the viewpoint of conductivity, copper, gold, or silver is preferable and copper is more preferable.

In addition, the film thickness of the metal layer obtained by the electrolytic plating can be controlled by adjusting the concentration of a metal contained in the plating bath or the current density.

The embodiment of applying metal ions has been described in the above description, but the present invention is not limited to such an embodiment, and a known plating catalyst such as metal fine particles may be used.

The thickness of the metal layer to be formed by the above-described procedures is not particularly limited and the optimal thickness can be suitably selected according to the intended use, but it is preferably 0.1 μm or greater, more preferably 0.5 μm or greater, and still more preferably 1 to 30 μm, from the viewpoint of conductive properties.

Moreover, the type of metal constituting the metal layer is not particularly limited and examples thereof include copper, chromium, lead, nickel, gold, silver, tin, and zinc. Among them, from the viewpoint of conductivity, copper, gold, or silver is preferable and copper or silver is more preferable.

The pattern shape of the metal layer is not particularly limited, but the metal layer may have, for example, a mesh pattern because the metal layer is disposed on the patterned plating layer, so that the shape thereof is adjusted by the pattern shape of the patterned plating layer. The metal layer having a mesh pattern can be suitably applied as a sensor electrode in a touch panel. In the case where the pattern shape of the metal layer is a mesh pattern, the range of the length W of one side of the lattice (opening portion) in the mesh pattern, the suitable embodiment of the lattice shape, and the line width of the metal layer are the same as in the above-described embodiment of a patterned plating layer.

(Primer Layer)

As another example of the embodiment of the conductive film, a primer layer may be further provided on the substrate. More specifically, as shown in a conductive film 100′ of FIG. 3, a primer layer 40 may be further disposed adjacent to a substrate 12. By providing the primer layer between the substrate and the patterned plating layer, the adhesiveness therebetween is further improved.

The thickness of the primer layer is not particularly limited, but it is generally preferably 0.01 to 100 μm, more preferably 0.05 to 20 μm, and still more preferably 0.05 to 10 μm.

The material of the primer layer is not particularly limited, but a resin having excellent adhesiveness to the substrate is preferable. A specific example of the resin may be a thermosetting resin or a thermoplastic resin or a mixture thereof. Examples of the thermosetting resin include an epoxy resin, a phenolic resin, a polyimide resin, a polyester resin, a bismaleimide resin, a polyolefin-based resin, and an isocyanate-based resin. Examples of the thermoplastic resin include a phenoxy resin, polyether sulfone, polysulfone, polyphenylene sulfone, polyphenylene sulfide, polyphenyl ether, polyether imide, and an acrylonitrile-butadiene-styrene copolymer (ABS) resin.

The thermoplastic resin or the thermosetting resin may be respectively used alone or in combination of two or more thereof. Further, a resin containing a cyano group may be used. Specifically, an ABS resin or “a polymer including a unit that has a cyano group in the side chain” described in paragraphs [0039] to [0063] of JP2010-84196A may be used.

Moreover, rubber components such as an acrylonitrile butadiene rubber (NBR rubber) and a styrene butadiene rubber (SBR rubber) may also be used.

One suitable embodiment of the material constituting the primer layer may be, for example, a polymer having a conjugated diene compound unit which may be hydrogenated. The conjugated diene compound unit refers to a repeating unit derived from a conjugated diene compound. The conjugated diene compound is not particularly limited as long as it is a compound having a molecular structure having two carbon-carbon double bonds separated by one single bond.

One suitable embodiment of the repeating unit derived from a conjugated diene compound may be, for example, a repeating unit generated by a polymerization reaction of a compound having a butadiene skeleton.

The conjugated diene compound unit may be hydrogenated, and in the case of containing a hydrogenated conjugated diene compound unit, adhesiveness of the metal layer is further improved, which is preferable. That is, a double bond in the repeating unit derived from a conjugated diene compound may be hydrogenated.

A polymer having the conjugated diene compound unit which may be hydrogenated may include the above-described interacting group.

Examples of the suitable embodiment of this polymer include an acrylonitrile butadiene rubber (NBR), a carboxyl group-containing nitrile rubber (XNBR), an acrylonitrile-butadiene-isoprene rubber (NBIR), an acrylonitrile-butadiene-styrene copolymer (ABS resin), and hydrogenated products thereof (for example, hydrogenated acrylonitrile butadiene rubber).

The primer layer may contain other additives (such as a sensitizer, an antioxidant, an antistatic agent, an ultraviolet absorbing agent, a filler, a particle, a flame retardant, a surfactant, a lubricant, and a plasticizer).

The method of forming a primer layer is not particularly limited, and examples thereof include a method of laminating a resin to be used on a substrate and a method of dissolving necessary components in a solvent which is capable of dissolving the components, applying the resulting coating liquid onto the surface of the substrate by a coating method or the like, and drying the surface thereof.

The heating temperature and the heating time in the coating method are selected depending on conditions in which a solvent to be applied can be sufficiently dried. From the viewpoint of production suitability, it is preferred that heating conditions of a heating temperature of 200° C. or lower for 60 minutes or less are selected and it is more preferred that heating conditions of a heating temperature of 40° C. to 100° C. for 20 minutes or less are selected. In addition, as for the solvent to be used, an optimal solvent (for example, cyclohexanone or methyl ethyl ketone) is appropriately selected according to the resin to be used.

In the case of using a substrate on which the primer layer is disposed, a desired conductive film is obtained by carrying out the foregoing Step 1 and Step 2 on the primer layer.

[Applications]

The conductive film having a metal layer obtained by the foregoing treatment can be applied to various uses and can be applied to various applications such as a touch panel (or a touch panel sensor), a semiconductor chip, various electric wiring boards, a flexible printed circuit (FPC), a chip on film (COF), a tape automated bonding (TAB), an antenna, a multilayer wiring board, and a mother board. Among them, it is preferable to use such a conductive film for a touch panel sensor (capacitive touch panel sensor). In the case where the conductive laminate is applied to a touch panel sensor, the metal layer in the conductive film functions as a detection electrode or a lead-out wiring in the touch panel sensor.

In the present specification, a combination of a touch panel sensor and various display devices (for example, a liquid crystal display device and an organic electroluminescence (EL) display device) is called a touch panel. The touch panel is preferably, for example, a so-called capacitive touch panel.

### EXAMPLES

Hereinafter, the present invention will be described in more detail with reference to the Examples, but the present invention is not limited thereto.

### Example 1

Polyacrylic acid (viscosity: 8,000 to 12,000 cp, manufactured by Wako Pure Chemical Industries, Ltd.), tetrafunctional acrylamide A (a monomer in which all of “R's” in General Formula (4) represent a methyl group, synthesized according to JP5486536B) as a polyfunctional monomer, and monofunctional acrylamide (N-t-butylacrylamide) as a monofunctional monomer were dissolved at a solid content mass ratio of 1:0.33:0.33 in isopropanol, and then Irgacure 127 (polymerization initiator, manufactured by BASF Corporation) was dissolved therein so as to be 5 mass % with respect to the total mass of the polyfunctional monomer and the monofunctional monomer, thereby preparing a composition for forming a plating layer having a solid content concentration of 3 mass % (hereinafter, also referred to as a “composition”).

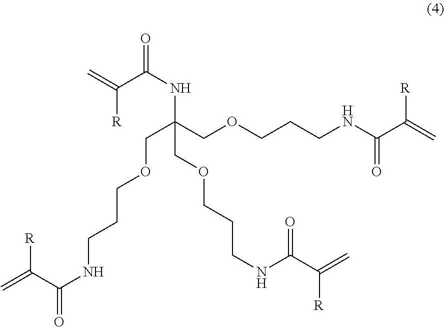

The obtained composition was applied onto a polyethylene terephthalate film (trade name “A4300”, manufactured by Toyobo Co., Ltd.) with MICROGRAVURE to form a plating layer precursor layer. The resulting plating layer precursor layer was irradiated with light having a wavelength of 254 nm (exposure amount of 9 mW/cm²) for 150 seconds by using a parallel exposure machine through a photo mask, and thereafter, the exposed plating layer precursor layer was subjected to a development treatment with an aqueous sodium carbonate solution to obtain a patterned plating layer (line width 3±0.3 μm). Thereafter, the patterned plating layer was washed with water, and the film having the patterned plating layer was immersed in a Pd catalyst applying liquid (manufactured by R&H Company) at 30° C. for 5 minutes. Next, the resulting film was washed with water, and the water-washed film was immersed in a metal catalyst reducing liquid (manufactured by R&H Company) at 30° C. Further, the resulting film was washed with water, and the water-washed film was immersed in a copper plating liquid (manufactured by R&H Company) at 30° C. for 15 minutes.

As a result, a conductive film having a metal layer (metal wiring) in which the entire area of the patterned plating layer (hereinafter, also simply referred to as a “pattern”) was covered with copper plating was obtained. With respect to the obtained metal layer (metal wiring), evaluation of the resistance value and evaluation of adhesiveness between the patterned plating layer and the metal layer were respectively carried out by the following method.

<Evaluation of Resistance Value>

Twenty pad portions and ten metal wirings (fine line width: 4 μm) independent of each other and each connecting two pad portions were formed on the substrate by the photo mask described above. The resistance values between the pads were measured using a tester, and the average value thereof was calculated.

It was evaluated according to the following standards. The results are shown in

Table 1.

“A”: The resistance value is sufficiently low.

“B”: The resistance value is low.

“C”: The resistance value is slightly high.

“D”: The resistance value is high.

<Evaluation of Adhesiveness>

A cellophane tape peeling test was carried out. Using a cellophane tape (“CT24” manufactured by Nichiban Co., Ltd.), after firmly sticking the cellophane tape film to the metal layer side of a conductive film with the ball of a finger, and then the cellophane tape was peeled off.

The evaluation was made according to the following standards. The results are shown in Table 1.

“A”: The adhesiveness between the metal layer and the patterned plating layer is satisfactory.

“B”: The adhesiveness between the metal layer and the patterned plating layer is slightly satisfactory.

“C”: There is a region where the adhesiveness between the metal layer and the patterned plating layer is somewhat weak.

“D”: The adhesiveness between the metal layer and the patterned plating layer is weak, resulting in interfacial peeling in the tape peeling test.

The metal wiring of Example 1 exhibited a sufficiently low resistance value, and satisfactory adhesiveness between the metal layer and the patterned plating layer.

### Example 2

A plating layer precursor layer was formed in the same manner as in Example 1, patterned to a line width of 1 μm or less, and then subjected to a copper plating treatment. As a result, a metal wiring in which the entire area of the pattern was covered with copper plating was obtained. The resistance value was sufficiently low, and the adhesiveness between the metal layer and the patterned plating layer was also satisfactory.

### Example 3

Film formation and plating treatment were carried out in the same manner as in Example 1, with the mixing ratio of tetrafunctional acrylamide A and monofunctional acrylamide being set to 1:0.33. As a result, a metal wiring in which the entire area of the pattern was covered with copper plating was obtained. The resistance value was low, and adhesiveness between the metal layer and the patterned plating layer was also satisfactory.

### Example 4

Film formation and plating treatment were carried out in the same manner as in Example 1, with the mixing ratio of tetrafunctional acrylamide A and monofunctional acrylamide being set to 1:0.15. As a result, a metal wiring in which the entire area of the pattern was covered with copper plating was obtained. The resistance value was low, and adhesiveness between the metal layer and the patterned plating layer was slightly satisfactory.

### Example 5

Film formation and plating treatment were carried out in the same manner as in Example 1, with the mixing ratio of tetrafunctional acrylamide A and monofunctional acrylamide being set to 1:0.10. As a result, a metal wiring in which the entire area of the pattern was covered with copper plating was obtained. The resistance value was slightly high, and adhesiveness between the metal layer and the patterned plating layer was slightly satisfactory.

### Example 6

Film formation and plating treatment were carried out in the same manner as in Example 1, with the mixing ratio of tetrafunctional acrylamide A and monofunctional acrylamide being set to 1:8. As a result, a metal wiring in which the entire area of the pattern was covered with copper plating was obtained. The resistance value was sufficiently low, and adhesiveness between the metal layer and the patterned plating layer was also satisfactory.

### Example 7

Film formation and plating treatment were carried out in the same manner as in Example 1, with the mixing ratio of tetrafunctional acrylamide A and monofunctional acrylamide being set to 1:50. As a result, a metal wiring in which the entire area of the pattern was covered with copper plating was obtained. The resistance value was sufficiently low, and adhesiveness between the metal layer and the patterned plating layer was also satisfactory.

### Example 8

Film formation and plating treatment were carried out in the same manner as in Example 1, with the mixing ratio of tetrafunctional acrylamide A and monofunctional acrylamide being set to 1:150. As a result, a metal wiring in which the entire area of the pattern was covered with copper plating was obtained. The resistance value was sufficiently low, and adhesiveness between the metal layer and the patterned plating layer was also satisfactory.

### Example 9

Film formation and plating treatment were carried out in the same manner as in Example 1, with the mixing ratio of tetrafunctional acrylamide A and monofunctional acrylamide being set to 1:500. As a result, a metal wiring in which the entire area of the pattern was covered with copper plating was obtained. The resistance value was low, and adhesiveness between the metal layer and the patterned plating layer was slightly satisfactory.

### Example 10

Film formation and plating treatment were carried out in the same manner as in Example 1, with the mixing ratio of tetrafunctional acrylamide A and monofunctional acrylamide being set to 1:1000. As a result, a metal wiring in which the entire area of the pattern was covered with copper plating was obtained. The resistance value was low, and there was a region with somewhat weak adhesiveness between the metal layer and the patterned plating layer.

### Example 11

Film formation and plating treatment were carried out in the same manner as in Example 1, with the mixing ratio of the polymer and the mixed monomers (the mixing ratio of tetrafunctional acrylamide A and monofunctional acrylamide is 1:1) being set to 1:0.20. As a result, a metal wiring in which the entire area of the pattern was covered with copper plating was obtained. The resistance value was low, and adhesiveness between the metal layer and the patterned plating layer was slightly satisfactory.

### Example 12

Film formation and plating treatment were carried out in the same manner as in Example 1, with the mixing ratio of the polymer and the mixed monomers (the mixing ratio of tetrafunctional acrylamide A and monofunctional acrylamide is 1:1) being set to 1:0.10. As a result, the plating rate was slightly low, and it was necessary to prolong the plating time in order to cover the entire area of the pattern with copper plating. The resistance value was low, and adhesiveness between the metal layer and the patterned plating layer was slightly satisfactory.

### Example 13

Film formation and plating treatment were carried out in the same manner as in Example 1, with the mixing ratio of the polymer and the mixed monomers (the mixing ratio of tetrafunctional acrylamide A and monofunctional acrylamide is 1:1) being set to 1:8. As a result, a metal wiring in which the entire area of the pattern was covered with copper plating was obtained. The resistance value was low, and adhesiveness between the metal layer and the patterned plating layer was slightly satisfactory.

### Example 14

Film formation and plating treatment were carried out in the same manner as in Example 1, with the mixing ratio of the polymer and the mixed monomers (the mixing ratio of tetrafunctional acrylamide A and monofunctional acrylamide is 1:1) being set to 1:10. As a result, the plating rate was slightly low, and it was necessary to prolong the plating time in order to cover the entire area of the pattern with copper plating. The resistance value was low, and adhesiveness between the metal layer and the patterned plating layer was slightly satisfactory.

### Example 15

Film formation and plating treatment were carried out in the same manner as in Example 1, using isopropylacrylamide as a monofunctional monomer. As a result, a metal wiring in which the entire area of the pattern was covered with copper plating was obtained. The resistance value of the wiring pattern was sufficiently low, and adhesiveness between the metal layer and the patterned plating layer was also satisfactory.

### Example 16

Film formation and plating treatment were carried out in the same manner as in Example 1, using diacetone acrylamide as a monofunctional monomer. As a result, a metal wiring in which the entire area of the pattern was covered with copper plating was obtained. The resistance value of the wiring pattern was sufficiently low, and adhesiveness between the metal layer and the patterned plating layer was also satisfactory.

### Example 17

Film formation and plating treatment were carried out in the same manner as in Example 1, using hydroxymethylacrylamide as a monofunctional monomer. As a result, a metal wiring in which the entire area of the pattern was covered with copper plating was obtained. The resistance value of the wiring pattern was sufficiently low, and adhesiveness between the metal layer and the patterned plating layer was also satisfactory.

### Example 18

Film formation and plating treatment were carried out in the same manner as in Example 1, using N-butoxymethylacrylamide as a monofunctional monomer. As a result, a metal wiring in which the entire area of the pattern was covered with copper plating was obtained. The resistance value of the wiring pattern was sufficiently low, and adhesiveness between the metal layer and the patterned plating layer was also satisfactory.

### Example 19

Film formation and plating treatment were carried out in the same manner as in Example 1, using 2-acrylamido-2-methylpropanesulfonic acid as a monofunctional monomer. As a result, a metal wiring in which the entire area of the pattern was covered with copper plating was obtained. The resistance value of the wiring pattern was slightly high, and adhesiveness between the metal layer and the patterned plating layer was slightly satisfactory.

### Example 20

Film formation and plating treatment were carried out in the same manner as in Example 1, using difunctional acrylamide B (a monomer represented by General Formula (B), synthesized according to paragraph [0187] of Journal of technical disclosure 2013-502632) as a polyfunctional monomer and diacetone acrylamide as a monofunctional monomer. As a result, a metal wiring in which the entire area of the pattern was covered with copper plating was obtained. The resistance value of the wiring pattern was sufficiently low, and adhesiveness between the metal layer and the patterned plating layer was also satisfactory.

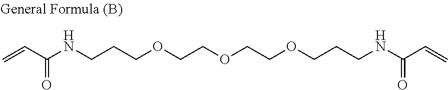 [SMILES: C=CC(=O)NCCCOCCOCCOCCCNC(=O)C=C]

### Example 21

Film formation and plating treatment were carried out in the same manner as in Example 14, except that the mixing ratio of the polyfunctional monomer and the monofunctional monomer in Example 20 was changed to 1:10. As a result, a metal wiring in which the entire area of the pattern was covered with copper plating was obtained. The resistance value was sufficiently low, and adhesiveness between the metal layer and the patterned plating layer was also satisfactory.

### Comparative Example 1

Film formation and plating treatment were carried out in the same manner as in Example 1, using only N,N′-methylenebisacrylamide as a monomer. As a result, a metal wiring in which the entire area of the pattern was covered with copper plating was obtained. The resistance value was high, and adhesiveness between the metal layer and the patterned plating layer was weak, resulting in interfacial peeling in the tape peeling test.

The evaluation results of Examples 1 to 21 and Comparative Example 1 are summarized in Table 1.

TABLE 1

| | | | | Mixing ratio | | | |
|---|---|---|---|---|---|---|---|
| | | | | | Polymer/ | | |
| | | | | Monomers*² | monomer*³ | Evaluation | |
| | | Polyfunctional | Monofunctional | mixing ratio | mixing ratio | Resistance | |
| | Polymer | monomer | monomer | (mass ratio) | (mass ratio) | value | Adhesiveness |
| Example 1 | Polyacrylic | Tetrafunctional | N-t-Butylacrylamide | 1:1 | 1:0.66 | A | A |
| | acid | acrylamide A | | | | | |
| Example 2*¹ | Polyacrylic | Tetrafunctional | N-t-Butylacrylamide | 1:1 | 1:0.66 | A | A |
| | acid | acrylamide A | | | | | |
| Example 3 | Polyacrylic | Tetrafunctional | N-t-Butylacrylamide | 1:0.33 | 1:0.66 | B | A |
| | acid | actylamide A | | | | | |
| Example 4 | Polyacrylic | Tetrafunctional | N-t-Butylacrylamide | 1:0.15 | 1:0.66 | B | B |
| | acid | aciylamide A | | | | | |
| Example 5 | Polyacrylic | Tetrafunctional | N-t-Butylacrylamide | 1:0.10 | 1:0.66 | C | B |
| | acid | acrylamide A | | | | | |
| Example 6 | Polyacrylic | Tetrafunctional | N-t-Butylacrylamide | 1:8 | 1:0.66 | A | A |
| | acid | acrylamide A | | | | | |
| Example 7 | Polyacrylic | Tetrafunctional | N-t-Butylacrylamide | 1:50 | 1:0.66 | A | A |
| | acid | acrylamide A | | | | | |
| Example 8 | Polyacrylic | Tetrafunctional | N-t-Butylacrylamide | 1:150 | 1:0.66 | A | A |
| | acid | acrylamide A | | | | | |
| Example 9 | Polyacrylic | Tetrafunctional | N-t-Butylacrylamide | 1:500 | 1:0.66 | B | B |
| | acid | acrylamide A | | | | | |
| Example 10 | Polyacrylic | Tetrafunctional | N-t-Butylacrylamide | 1:1000 | 1:0.66 | B | C |
| | acid | acrylamide A | | | | | |
| Example 11 | Polyacrylic | Tetrafunctional | N-t-Butylacrylamide | 1:1 | 1:0.20 | B | B |
| | acid | acrylamide A | | | | | |
| Example 12*¹ | Polyacrylic | Tetrafunctional | N-t-Butylacrylamide | 1:1 | 1:0.10 | B | B |
| | acid | acrylamide A | | | | | |
| Example 13 | Polyacrylic | Tetrafunctional | N-t-Butylacrylamide | 1:1 | 1:8 | B | B |
| | acid | acrylamide A | | | | | |
| Example 14*¹ | Polyacrylic | Tetrafunctional | N-t-Butylacrylamide | 1:1 | 1:10 | B | B |
| | acid | acrylamide A | | | | | |
| Example 15 | Polyacrylic | Tetrafunctional | Isopropylacrylamide | 1:1 | 1:0.66 | A | A |
| | acid | acrylamide A | | | | | |
| Example 16 | Polyacrylic | Tetrafunctional | Diacetone acrylamide | 1:1 | 1:0.66 | A | A |
| | acid | acrylamide A | | | | | |
| Example 17 | Polyacrylic | Tetrafunctional | Hydroxymethylacrylamide | 1:1 | 1:0.66 | A | A |
| | acid | acrylamide A | | | | | |
| Example 18 | Polyacrylic | Tetrafunctional | Butoxymethylacrylamide | 1:1 | 1:0.66 | A | A |
| | acid | acrylamide A | | | | | |
| Example 19 | Polyacrylic | Tetrafunctional | 2-Acrylamido-2- | 1:1 | 1:0.66 | C | B |
| | acid | acrylamide A | methylpropan esulfonic | | | | |
| | | | acid | | | | |
| Example 20 | Polyacrylic | Difunctional | Diacetone acrylamide | 1:1 | 1:0.66 | A | A |
| | acid | acrylamide B | | | | | |
| Example 21 | Polyacrylic | Difunctional | Diacetone acrylamide | 1:10 | 1:0.66 | A | A |
| | acid | acrylamide B | | | | | |
| Comparative | Polyacrylic | Methylenebi- | None | 1:0 | 1:0.66 | D | D |
| Example 1 | acid | sacrylamide | | | | | |

*¹Example 2 was carried out in a pattern width of 1 μm. Examples 12 and 14 were carried out by prolonging a plating time by 5 minutes.
*²In the table, monomers mixing ratio (mass ratio) refers to a mixing ratio of polyfunctional monomer:monofunctional monomer.
*³In the table, polymer/monomer mixing ratio (mass ratio) refers to a mixing ratio of polymer:total content of polyfunctional monomer and monofunctional monomer.

As shown in Table 1, it was confirmed that the resistance value was low and the adhesiveness between the metal layer and the patterned plating layer was excellent in the case where the composition for forming a plating layer according to the present invention was used. It was also confirmed that the composition for forming a plating layer according to the present invention is capable of drawing high quality fine lines.

From the comparison of Examples 1 and 15 to 20, it was confirmed that the effect was more excellent in the case where the compound represented by General Formula (1) was used as the monofunctional monomer.

Further, from the comparison of Examples 1 and 3 to 10, it was confirmed that the effect was more excellent by setting the content of the polyfunctional monomer and the content of the monofunctional monomer to a specific ratio (the content of the monofunctional monomer was more preferably 15 to 50,000 parts by mass, still more preferably 30 to 20,000 parts by mass, and particularly preferably 100 to 15,000 parts by mass, with respect to 100 parts by mass of the polyfunctional monomer).

Further, from the comparison of Examples 1 and 11 to 14, it was confirmed that the effect was more excellent by setting the content of the non-polymerizable polymer having a group capable of interacting with a metal ion and the total content of the polyfunctional monomer and the monofunctional monomer to a specific ratio (it is preferred that the total content of the polyfunctional monomer and the monofunctional monomer is set to 50 to 500 parts by mass with respect to 100 parts by mass of the non-polymerizable polymer having a group capable of interacting with a metal ion.).

It should be noted that Comparative Example 1, which does not use a predetermined component, corresponds to the embodiment of Example 10 of JP2009-218509A, and it was confirmed that desired effects cannot be obtained in this embodiment.

### EXPLANATION OF REFERENCES

10: film having plating layer precursor layer
50: film having patterned plating layer
12: substrate
20: patterned plating layer
22: metal layer
30: coating film (plating layer precursor layer)
40: primer layer
100, 100′: conductive film

What is claimed is:

1. A composition for forming a plating layer, comprising:
a non-polymerizable polymer having a group capable of interacting with a metal ion;
a polyfunctional monomer having two or more polymerizable functional groups;
a monofunctional monomer; and
a polymerization initiator.

2. The composition for forming a plating layer according to claim 1,
wherein the polymer has a repeating unit containing a carboxylic acid group or a sulfonic acid group.

3. The composition for forming a plating layer according to claim 1,
wherein the polymer is poly(meth)acrylic acid.

4. The composition for forming a plating layer according to claim 2,
wherein the polymer is poly(meth)acrylic acid.

5. The composition for forming a plating layer according to claim 1,
wherein at least one of the polyfunctional monomer or the monofunctional monomer has a (meth)acrylamide group.

6. The composition for forming a plating layer according to claim 2,
wherein at least one of the polyfunctional monomer or the monofunctional monomer has a (meth)acrylamide group.

7. The composition for forming a plating layer according to claim 3,
wherein at least one of the polyfunctional monomer or the monofunctional monomer has a (meth)acrylamide group.

8. The composition for forming a plating layer according to claim 1,
wherein the monofunctional monomer contains at least a compound represented by General Formula (1), 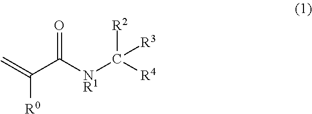
where R⁰ represents a hydrogen atom or an alkyl group having 1 to 4 carbon atoms, R¹ represents a hydrogen atom or an alkyl group having 1 to 4 carbon atoms, R², R³, and R⁴ each independently represent a hydrogen atom, a hydroxy group, an alkyl group having 1 to 10 carbon atoms, or a hydrocarbon chain partially having a substituent selected from an ether group, a carbonyl group, a carboxyl group, and a hydroxy group.

9. The composition for forming a plating layer according to claim 2,
wherein the monofunctional monomer contains at least a compound represented by General Formula (1), 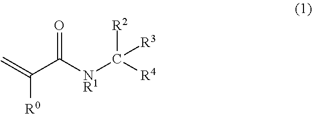
where R⁰ represents a hydrogen atom or an alkyl group having 1 to 4 carbon atoms, R¹ represents a hydrogen atom or an alkyl group having 1 to 4 carbon atoms, R², R³, and R⁴ each independently represent a hydrogen atom, a hydroxy group, an alkyl group having 1 to 10 carbon atoms, or a hydrocarbon chain partially having a substituent selected from an ether group, a carbonyl group, a carboxyl group, and a hydroxy group.

10. The composition for forming a plating layer according to claim 1,
wherein the polyfunctional monomer contains at least a tetrafunctional (meth)acrylamide.

11. The composition for forming a plating layer according to claim 2,
wherein the polyfunctional monomer contains at least a tetrafunctional (meth)acrylamide.

12. The composition for forming a plating layer according to claim 1,
wherein the content of the monofunctional monomer is 10 to 100,000 parts by mass with respect to 100 parts by mass of the polyfunctional monomer.

13. The composition for forming a plating layer according to claim 2,
wherein the content of the monofunctional monomer is 10 to 100,000 parts by mass with respect to 100 parts by mass of the polyfunctional monomer.

14. The composition for forming a plating layer according to claim 1,
wherein the total content of the polyfunctional monomer and the monofunctional monomer is 10 to 1,000 parts by mass with respect to 100 parts by mass of the polymer.

15. The composition for forming a plating layer according to claim 2,
wherein the total content of the polyfunctional monomer and the monofunctional monomer is 10 to 1,000 parts by mass with respect to 100 parts by mass of the polymer.

16. A film having a plating layer precursor layer, comprising:
a substrate; and
a plating layer precursor layer formed of the composition for forming a plating layer according to claim 1 on the substrate.

17. The film having a plating layer precursor layer according to claim 16, further comprising:
a primer layer between the substrate and the plating layer precursor layer.

18. A film having a patterned plating layer,
wherein the plating layer precursor layer the film having a plating layer precursor layer according to claim 16 is cured in a patternwise manner by energy application to form a patterned plating layer.

19. A conductive film obtained by laminating a metal layer on the patterned plating layer of the film having a patterned plating layer according to claim 18.

20. A touch panel comprising:
the conductive film according to claim 19.
